(19) United States
(12) Patent Application Publication
(10) Pub. No.: US 2014/0322426 A1
(43) Pub. Date: Oct. 30, 2014

(54) Method for extracting coffee liquid and extraction solvent for extracting coffee liquid

(71) Applicant: Keiichi FUJII, Hyogo (JP)

(72) Inventor: Keiichi FUJII, Hyogo (JP)

(21) Appl. No.: 14/266,864

(22) Filed: May 1, 2014

Related U.S. Application Data
(63) Continuation of application No. PCT/JP2012/079163, filed on Nov. 9, 2012.

(30) Foreign Application Priority Data
Nov. 9, 2011 (JP) 2011-246000

(51) Int. Cl. A23F 5/26

(52) U.S. Cl. CPC A23F 5/267
USPC 426/590; 426/433

(57) ABSTRACT

A method of extracting a coffee liquid includes the step of extracting crashed coffee beans using an extraction aqueous solution containing a fruit sugar condensation compound formed of a plurality of fructose molecules through condensation.

### BACKGROUND OF THE INVENTION AND RELATED ART STATEMENT

The present invention relates to a method of extracting a coffee liquid and an extraction solvent for extracting a coffee liquid.

Nowadays, coffee has been one of most consumed beverages, and a wide range of commercial products has been available including various types of goods such as a canned product, a plastic bottled product, a paper container product, and so on. Naturally, coffee has become one of daily necessities for many people, and as a consequence, there have been numerous efforts to improve a method of efficiently extracting a coffee liquid.

For example, Patent Reference has disclosed a method of producing a coffee beverage, in which a coffee liquid is extracted using a milk-based aqueous solution at a temperature between 80° C. and 100° C. When the method disclosed in Patent Reference is applied to an actual production of a coffee beverage, it is possible to improve an extraction efficiency of a poly-phenol compound in the product. Further, it is possible to obtain a deep coffee color with high quality while maintaining profound flavor.
Patent Reference: Japanese Patent Application Publication No. 05-161452

In the prior art, it has been known that a difructose anhydride (referred to as a DFA) is formed of a cyclic disaccharide comprised of two fructose molecules, and it has been confirmed that difructose anhydride is effective to promote absorption of various nutrients through a number of experiments using human and animals. Further, it has been known that difructose anhydride is a naturally existing substance, and is proven to be safe to human.

As explained above, when the coffee liquid is extracted, contents and flavor of the coffee liquid significantly depend on the extraction method. An object of the invention is to provide a novel method of extracting a coffee liquid and an extraction solvent for extracting a coffee liquid.

### SUMMARY OF THE INVENTION

In order to attain the objects described above, according to a first aspect of the present invention, a novel method of extracting a coffee liquid is characterized that an extraction solvent contains a fruit sugar condensation compound formed of a plurality of fructose molecules through condensation, and the extraction solvent is used to extract the coffee liquid from crashed coffee beans. It should be noted that the fruit sugar condensation compound is defined as a condensation compound obtained through condensing a plurality of fructose molecules. According to the aspect of the present invention, it is preferred that the condensation compound of fruit sugar is a cyclic disaccharide comprised of two fructose molecules, and most preferably, difructose anhydrides I˜V (DFAI˜V) and a derivative thereof.

According to a second aspect of the present invention, in the method of extracting the coffee liquid in the first aspect, it is preferred that the extraction solvent contains the fruit sugar condensation compound at a concentration of 0.003 to 0.9 weight %.

According to a third aspect of the present invention, an extraction solvent for extracting a coffee liquid is an aqueous solution containing a fruit sugar condensation compound.

According to the present invention, the method of extracting the coffee liquid is characterized that the extraction solvent contains the fruit sugar condensation compound formed of a plurality of fructose molecules through condensation, and the extraction solvent is used to extract the coffee liquid from crashed coffee beans. Accordingly, it is possible to extract the coffee liquid containing a large extracted quantity of caffeine and poly-phenols. Further, it is possible to obtain the coffee liquid having bitterness and fragrance inherent to coffee while adequately suppressing sweetness. The extraction solvent for extracting the coffee liquid is the aqueous solution, yet includes a hydrophobic group. Accordingly, it is presumed that the hydrophobic group becomes compatible with an oily component of coffee, thereby efficiently extracting the oily component.

### BRIEF DESCRIPTION OF THE DRAWINGS

FIG. 1 is a graph showing an analysis result detecting a fruit sugar condensation compound in an aqueous solution example No. 1;

FIG. 2 is a graph showing an analysis result detecting a fruit sugar condensation compound in a coffee liquid;

FIG. 3 is a graph showing an analysis result showing an extraction amount of chlorogenic acid and caffeine in the coffee liquid;

FIG. 4 is a graph showing an analysis result showing an extraction amount of chlorogenic acid and caffeine in the coffee liquid;

FIG. 5 is a graph showing an analysis result showing an extraction amount of chlorogenic acid and caffeine in the coffee liquid; and

FIG. 6 is a graph showing an analysis result showing an extraction amount of chlorogenic acid and caffeine in the coffee liquid.

### DETAILED DESCRIPTION OF THE PREFERRED EMBODIMENTS

Hereunder, embodiments of the present invention will be explained with reference to the accompanying drawings.

In the embodiments, first, coffee beans are prepared through roasting and crashing, and then an extraction solvent is prepared. Afterward, the coffee beans are contacted with the extraction solvent, so that a coffee liquid is extracted. The extraction solvent may be heated at a temperature between 30° C. and 100° C., preferably between 60° C. and 100° C. Alternatively, the coffee beans may be contacted with the extraction solvent at a room temperature. In general, it has been said that a preferred extraction temperature is around 90° C. In the embodiments, however, the extraction solvent is not significantly affected by the temperature, and is capable of effectively extracting the coffee liquid at a wide range of temperatures. It should be noted that the method of extracting the coffee liquid from the coffee beans is not limited to a specific one as far as the extraction solvent is used.

In the embodiments, the coffee beans may include ones of a well-known type, and may be blended with various types. Further, the coffee beans may be roasted with any method at any temperature, and the coffee beans may be crashed with any method.

In the embodiments, the extraction solvent is an aqueous solution containing a fruit sugar condensation compound. A concentration of the fruit sugar condensation compound is not limited to a specific value, but is preferred to be greater than 0.003 weight %, more preferably, between 0.015 and 1.0 weight %. When the extraction solvent contains the fruit sugar condensation compound at a concentration less than 0.003 weight %, it is difficult to effectively extract the coffee liquid in a short period of time. Further, when the extraction solvent contains the fruit sugar condensation compound at a concentration less than 0.015 weight %, it is difficult to effectively mask negative flavor. Further, even when the extraction solvent contains the fruit sugar condensation compound at a concentration greater than 1.0 weight %, it is found that an extraction amount is not greatly increased. The extraction solvent may be an aqueous solution using drinking water as a solvent, and preferably using mineral water.

In the embodiments, the fruit sugar condensation compound is formed of a plurality of fructose molecules through condensation. In particular, the fruit sugar condensation compound is preferred to be a cyclic disaccharide comprised of two fructose molecules. The cyclic disaccharide includes DFAIII or DFAIV, which is formed through fermentation using an inulin degrading enzyme. Further, the cyclic disaccharide includes DFAI, DFAII, or DFAV, which is a condensation product of fruit sugars obtained through heating an aqueous solution containing the fruit sugars. It should be noted that the cyclic disaccharide may be produced with other method. The two fructose molecules may contain variety of derivatives, and are not specifically limited to specific ones.

In the embodiments, as opposed to a coffee liquid extracted from the same amount of coffee beans with ordinary drinking water, the coffee liquid extracted with the method described above is found to contain a larger amount of caffeine and poly-phenols as main components of the coffee liquid. Accordingly, when the coffee beans are extracted using the extraction solvent containing the fruit sugar condensation compound, it is possible to reduce an amount of the coffee beans.

As explained above, in the embodiments, the extraction solvent contains the fruit sugar condensation compound. It is found that a hydrophobic group of the fruit sugar condensation compound is able to wrap and mask bitter taste in a coffee beverage that is created when the coffee beans are extracted for a long period of time at a high temperature. Accordingly, it is possible to extract the coffee beans for a long period of time at a high temperature, which is difficult with the conventional method due to the resultant bitter taste. As a result, it is possible to increase an extraction amount almost two times, thereby making it possible to significantly reduce the usage of the coffee beans.

Further, in the embodiments, the fruit sugar condensation compound tends not to be easily oxidized due to anti-oxidation property thereof. Accordingly, it is possible to sterilize and store the coffee beverage at a high temperature, which is difficult with the conventional method due to deterioration of flavor such as sourness caused by oxidation.

### [Preparation of the Aqueous Solution Containing the Fruit Sugar Condensation Compound]

In the preparation, first, fruit sugar water is heated and condensed at a temperature greater than 100° C., and then a resultant liquid is diluted and cooled with water. Afterward, the liquid is filtered through an activated charcoal and the like, thereby obtaining an aqueous solution (referred to as an aqueous solution example No. 1) containing the fruit sugar condensation compound at a concentration of 30% weight %.

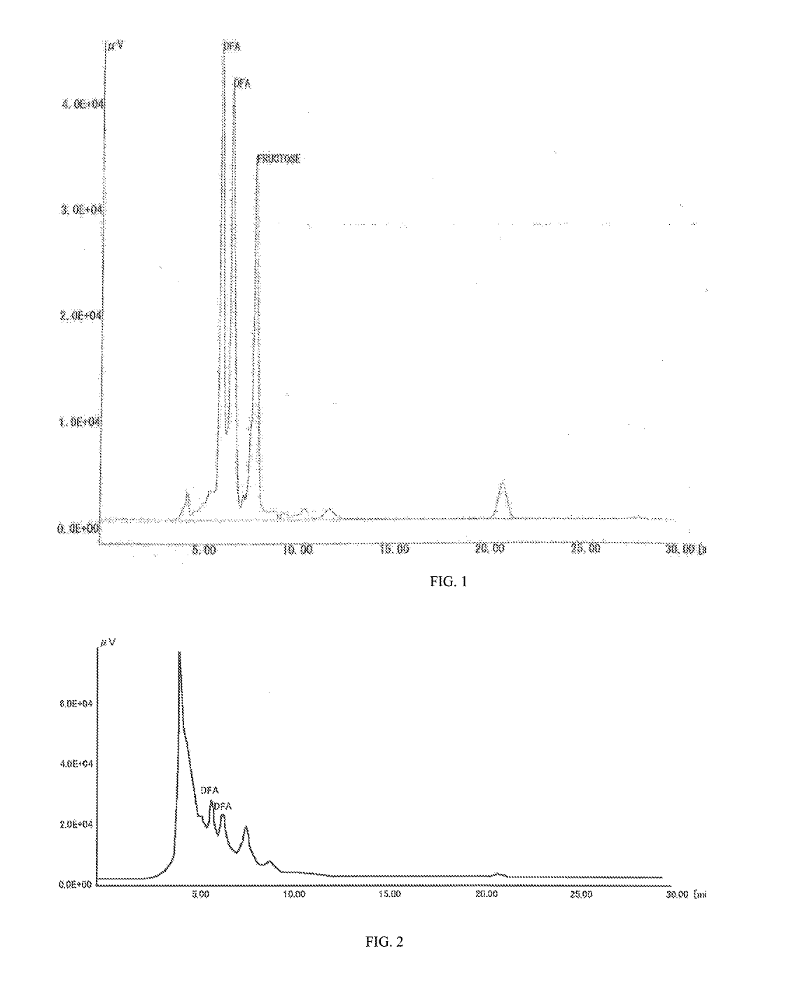

The aqueous solution example No. 1 is analyzed with the liquid chromatography. FIG. 1 is a graph showing an analysis result detecting the fruit sugar condensation compound in the aqueous solution example No. 1. As shown in FIG. 1, the analysis result of the aqueous solution example No. 1 exhibits three large peaks and several small peaks. Accordingly, it is confirmed that the aqueous solution example No. 1 contains two types of DFAs and fructose as main components, and further contains a plurality of the fruit sugar condensation compounds (the DFA derivatives other than DFAIII and DFAIV). As an aqueous solution example containing DFAIII, another aqueous solution example (referred to as an aqueous solution example No. 2) is prepared using Twintose (a registered product name of Fancl Corporation).

### [Evaluation 1]

An extraction aqueous solution (referred to as an extraction aqueous solution No. 1) containing the fruit sugar condensation compound at a concentration of 0.15% weight % is prepared from the aqueous solution example No. 1 described above. Afterward, the coffee beans (4.0 g, 6.0 g) are roasted and crashed, and are extracted through pouring into the extraction aqueous solution No. 1 that is heated to 100° C., thereby obtaining the coffee liquid as a first embodiment and a second embodiment. Further, a comparative example No. 1 is prepared through extracting with 100 ml of water. With respect to the coffee liquid in the first embodiment, the second embodiment, and the comparative example No. 1, an amount of caffeine (referred to as a Ca amount) and an amount of poly-phenol (referred to as a PP amount) are determined with the liquid chromatography, and flavor is evaluated. Table 1 shows results of the measurement and the flavor evaluation.

TABLE 1

| | Coffee | Ca | PP | |
|---|---|---|---|---|
| | beans | amount | amount | |
| | amount (g) | (ppm) | (ppm) | Flavor |
| First | 4.0 | 375 | 1680 | No bitterness and |
| embodiment | | | | sourness |
| Second | 6.0 | 440 | 1940 | No bitterness and |
| embodiment | | | | sourness |
| Comparative | 6.0 | 380 | 1700 | Slight bitterness |
| example No. 1 | | | | and sourness |

In the second embodiment, the coffee liquid is extracted using the extraction solution containing the fruit sugar condensation. On the other hand, in the comparative example No. 1, the coffee liquid is extracted using the extraction solution containing no fruit sugar condensation. As shown in Table 1, in the first embodiment, as opposed to the comparative example No. 1, it is possible to extract a larger amount of caffeine and poly-phenol. Further, in the first embodiment, the coffee liquid is extracted from 4.0 g of the coffee beans, as opposed to 6.0 g in the comparative example No. 1. As shown in Table 1, in the first embodiment, it is it is possible to extract a same amount of caffeine and poly-phenol. Accordingly, when the coffee liquid is extracted using the extraction solution containing the fruit sugar condensation, it is possible to extract the coffee liquid at a higher concentration from a smaller amount of the coffee beans. Further, the coffee liquid in the comparative example No. 1 shows slight bitterness and sourness. Accordingly, in the first embodiment and the second embodiment, it is presumed that the fruit sugar condensation prevents the coffee liquid from being excessively oxidized, and masks a harsh taste of the coffee liquid.

### [Evaluation 2]

Similar to the evaluation 1, the extraction aqueous solutions containing the fruit sugar condensation compound at concentrations of 0.005 to 5.0 weight % is prepared through diluting the aqueous solution example No. 1. Afterward, the coffee beans (6.0 g) are extracted through pouring into the extraction aqueous solutions, thereby obtaining the coffee liquids as third to ninth embodiments. Then, an amount of caffeine (referred to as a Ca amount) and an amount of poly-phenol (referred to as a PP amount) are determined with the liquid chromatography, and the flavor is evaluated. Table 2 shows results of the measurement and the flavor evaluation.

TABLE 2

| | Aqueous | fruit sugar | | | |
|---|---|---|---|---|---|
| | solution | condensation | Ca | PP | |
| | example | compound | amount | amount | |
| | No. 1 (%) | (%) | (ppm) | (ppm) | Flavor |
| Third | 0.005 | 0.0015 | 380 | 1700 | Slight |
| embodiment | | | | | bitterness |
| | | | | | and sourness |
| Fourth | 0.01 | 0.003 | 400 | 1750 | Slight |
| embodiment | | | | | bitterness |
| | | | | | and sourness |
| Fifth | 0.3 | 0.09 | 420 | 1890 | Almost no |
| embodiment | | | | | bitterness |
| | | | | | and sourness |
| Sixth | 0.5 | 0.15 | 440 | 1940 | No |
| embodiment | | | | | bitterness |
| | | | | | and sourness |
| Seventh | 1.0 | 0.3 | 460 | 2050 | No |
| embodiment | | | | | bitterness |
| | | | | | and sourness |
| Eighth | 3.0 | 0.9 | 450 | 2000 | Slight |
| embodiment | | | | | caramel |
| | | | | | flavor |
| Ninth | 5.0 | 1.5 | 440 | 1920 | Caramel |
| embodiment | | | | | flavor |
| Comparative | 0 | 0 | 380 | 1700 | Slight |
| example | | | | | bitterness |
| No. 1 | | | | | and sourness |

As shown in the results of the evaluation 2, when the extraction aqueous solutions contains the fruit sugar condensation compound less than 0.0015 weight % (refer to the third embodiment and later), the coffee liquid exhibits the same extraction amounts of caffeine and poly-phenol as those of the comparative example No. 1. In other words, when the extraction aqueous solutions contains the fruit sugar condensation compound greater than 0.0015 weight %, it is possible to improve the extraction amounts of caffeine and poly-phenol. Further, when the extraction aqueous solutions contains the fruit sugar condensation compound greater than 0.09 weight %, the coffee liquid exhibits no bitterness and sourness. On the other hand, when the extraction aqueous solutions contains the fruit sugar condensation compound greater than 0.3 weight %, the extraction amounts of caffeine and poly-phenol show no increase. Further, when the extraction aqueous solutions contains the fruit sugar condensation compound greater than 0.9 weight %, the coffee liquid does not exhibit bitterness and sourness, but exhibits caramel flavor.

### [Evaluation 3]

The coffee beans (6.0 g) are roasted and crashed, and are poured in 100 ml of the extraction aqueous solution No. 1 at a temperature of 100° C. Afterward, the extraction aqueous solution No. 1 is boiled for 10 minutes before dripped to obtain the coffee liquid as a tenth embodiment. Similarly, a comparative example No. 2 is prepared through extracting with 100 ml of water at a temperature of 100° C. without using the extraction aqueous solution No. 1. With respect to the coffee liquid in the tenth embodiment and the comparative example No. 2, the amount of caffeine and the amount of poly-phenol are determined with the liquid chromatography, and the flavor is evaluated. Table 3 shows results of the measurement and the flavor evaluation.

TABLE 3

| | Ca | PP | |
|---|---|---|---|
| | amount | amount | |
| | (ppm) | (ppm) | Flavor |
| Tenth | 720 | 3200 | No bitterness and |
| embodiment | | | sourness, deep |
| | | | flavor |
| Comparative | — | — | Strong bitterness |
| example No. 2 | | | and sourness, no |
| | | | coffee flavor |

As shown in the results of the evaluation 3, in the tech embodiment, the coffee liquid has deep coffee flavor without bitterness and sourness. On the other hand, the coffee liquid in the comparative example No. 2 has strong bitterness and sourness. From the results, it is presumed that the fruit sugar condensation compound prevents the coffee liquid from being oxidized and masks the harsh taste. It should be noted that the coffee liquid in the tech embodiment shows the amounts of caffeine and poly-phenol about double of those in the first to ninth embodiments.

### [Evaluation 4]

The coffee beans (6.0 g) are roasted and crashed, and are poured in 100 ml of the extraction aqueous solution No. 1 at a temperature of 100° C. Afterward, the coffee liquid is extracted through dripping. When the coffee liquid is analyzed with the liquid chromatography, it is confirmed that the coffee liquid contains at least two types of DFA (refer to FIG. 2).

### [Evaluation 5]

The coffee beans (6.0 g) are roasted and crashed, and are poured in 100 ml of the extraction aqueous solution No. 1 at a temperature of 100° C., so that the coffee liquid is extracted as an eleventh embodiment. Afterward, the coffee liquid is heated and maintained at temperature of 50° C., so that a change in the flavor of the coffee liquid is evaluated with time. Similarly, a comparative example No. 3 is prepared through extracting with 100 ml of hot water, and the coffee liquid is heated and maintained at temperature of 50° C., so that a change in the flavor of the coffee liquid is evaluated with time. Further, a comparative example No. 4 is prepared through extracting with 100 ml of hot water, and the aqueous solution example No. 1 is added at a concentration of 0.5 weight %. Then, the coffee liquid is heated and maintained at temperature of 50° C., so that a change in the flavor of the coffee liquid is evaluated with time. It should be noted that the coffee liquid is heated in an open environment, so that the coffee liquid is easily oxidized. Table 4 shows results of the flavor evaluation.

TABLE 4

| | Heating time (at 50° C.) | | |
|---|---|---|---|
| | 10 minutes | 60 minutes | 120 minutes |
| Eleventh | No change in | No change in | No change in |
| embodiment | flavor and | flavor and | flavor and |
| | taste before | taste before | taste before |
| | and after | and after | and after |
| | heating | heating | heating |
| Comparative | Stronger harsh | No coffee | No coffee |
| example N0. 3 | taste, | flavor | flavor |
| | bitterness, and | | |
| | sourness | | |
| Comparative | Stronger harsh | No coffee | No coffee |
| example N0. 3 | taste, | flavor | flavor |
| | bitterness, and | | |
| | sourness | | |

As shown in the results of the evaluation 5, in the eleventh embodiment, even after the coffee liquid is heated for a long period of time, the flavor is not deteriorated, and the coffee liquid maintains fresh coffee flavor just after the extraction without imparting harsh taste, bitterness, and sourness. On the other hand, the coffee liquid in the comparative example No. 3 has poor flavor even after 10 minutes heating, and the coffee flavor is disappeared after 60 minutes heating, so that the coffee liquid becomes no longer drinkable. It is presumed that the results are cause by the oxidation. Further, in the comparative example No. 4, in which the aqueous solution example No. 1 is added to the coffee liquid extracted with the hot water, harsh taste, bitterness, and sourness become stronger with time, and the flavor is deteriorated.

### [Evaluation 6]

Sodium carbonate is added to drinking water to prepare an alkali aqueous solution No. 1 with pH 8 and an alkali aqueous solution No. 2 with pH 9, respectively. Then, the aqueous solution example No. 1 is added at a concentration of 0.5 weight % to the alkali aqueous solution No. 1 and the alkali aqueous solution No. 2, thereby preparing an extraction aqueous solution No. 2 and an extraction aqueous solution No. 3. The coffee beans (6.0 g) are roasted and crashed, and are poured in 100 ml of the extraction aqueous solution No. 2 and the extraction aqueous solution No. 3 at a temperature of 100° C., so that the coffee liquid is extracted as a twelfth embodiment and a thirteenth embodiment, respectively. Further, the coffee beans (6.0 g) are poured in 100 ml of the alkali aqueous solution No. 1 and the alkali aqueous solution No. 2 at a temperature of 100° C., so that the coffee liquid is extracted as a comparative example No. 5 and a comparative example No. 6, respectively. Table 5 shows results of the flavor evaluation.

TABLE 5

| | Flavor evaluation |
|---|---|
| Twelfth embodiment | Natural inherent flavor and |
| | bitterness, good quality |
| Thirteenth embodiment | Natural inherent flavor and |
| | bitterness, good quality |
| Comparative example No. 5 | Less bitterness of main flavor |
| | of coffee |
| Comparative example No. 6 | No bitterness, poor flavor |

As shown in the results of the evaluation 6, in the twelfth embodiment and the thirteenth embodiment, when the extraction aqueous solution containing the fruit sugar condensation compound is adjusted to a slightly alkaline side, it is possible to preserve natural inherent flavor and bitterness of the coffee liquid, thereby making it possible to extract the coffee liquid having bitter and excellent flavor.

### [Evaluation 7]

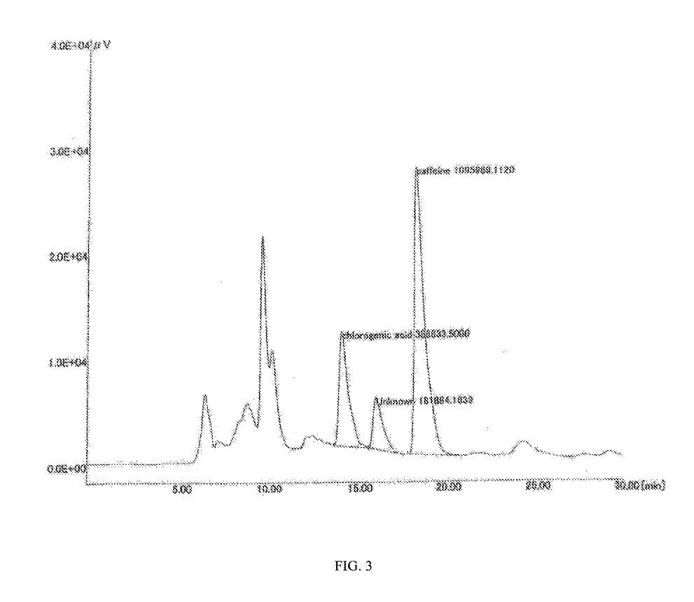

The aqueous solution example No. 2 described above is diluted with water to prepare an extraction aqueous solution (referred to an aqueous solution No. 4). Afterward, the coffee beans (5.0 g) are roasted and crashed, and are extracted through pouring into 150 ml of the extraction aqueous solution (containing the fruit sugar condensation compound at a concentration of 0.12 weight %) at 90° C., thereby obtaining the coffee liquid as a fourteenth embodiment. Similarly, the coffee beans (5.0 g) are roasted and crashed, and are extracted through pouring into 150 ml of the extraction aqueous solution (containing DFAIII at a concentration of 0.12 weight %) at 90° C., thereby obtaining the coffee liquid as a fifteenth embodiment. Further, the coffee beans (5.0 g) are roasted and roughly crashed, and are extracted through pouring into 150 ml and 90 ml of water (containing no additive) at 90° C., thereby obtaining the coffee liquid as comparative examples No. 7 and No. 8. Table 6 and FIGS. 3 to 6 show results of the measurement and the flavor evaluation.

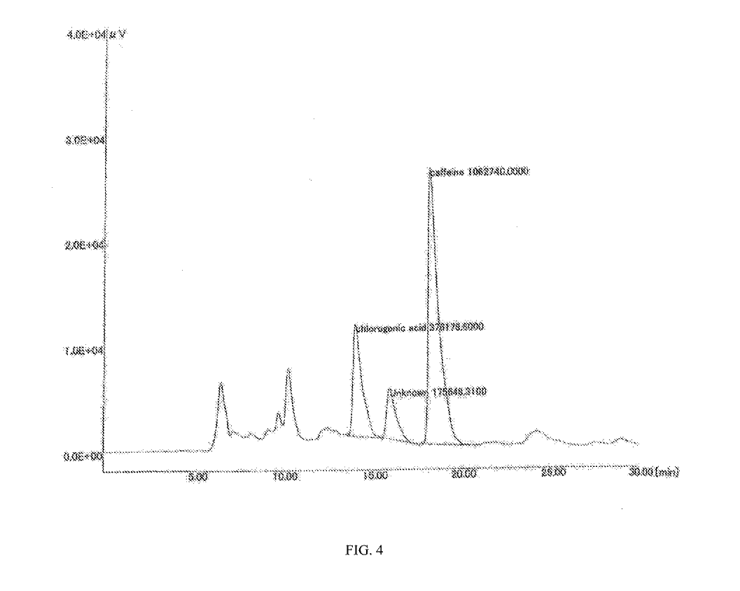

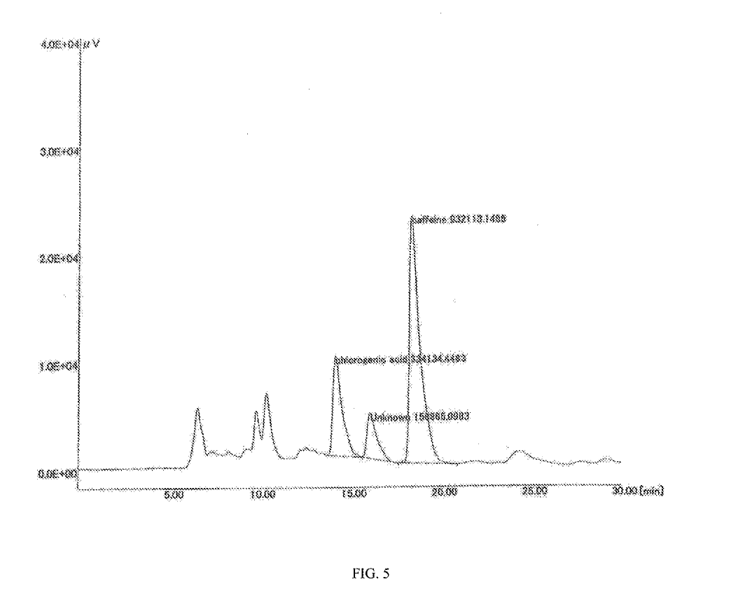

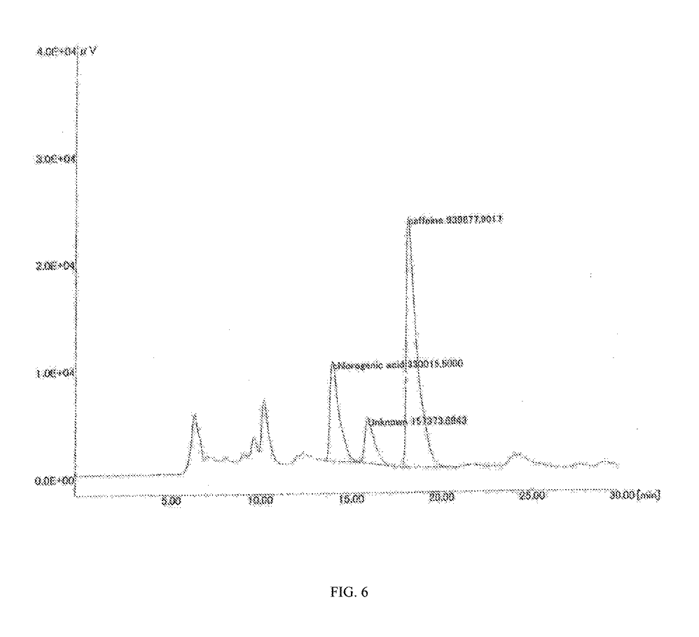

TABLE 6

| | fruit sugar | Ca | PP | |
|---|---|---|---|---|
| | condensation | amount | amount | |
| | compound (%) | (ppm) | (ppm) | Flavor |
| Thirteenth | 0.12 | 284.4 | 555.0 | Strong coffee flavor, |
| embodiment | | | | no bitterness and |
| (FIG. 3) | | | | sourness |
| Fifteenth | 0.12 | 274.4 | 540.0 | Slight coffee flavor, |
| embodiment | (DFAIII) | | | light flavor, no |
| (FIG. 4) | | | | bitterness and |
| | | | | sourness |
| Comparative | 0 (Fruit | 244.5 | 472.5 | Sweetness, weak |
| example No. 7 | sugar) | | | coffee flavor |
| (FIG. 5) | | | | |
| Comparative | 0 | 242.0 | 477.5 | Bitterness and |
| example No. 8 | | | | sourness |
| (FIG. 6) | | | | |

What is claimed is:

1. A method of extracting a coffee liquid, comprising the step of:
extracting crashed coffee beans using an extraction aqueous solution containing a fruit sugar condensation compound formed of a plurality of fructose molecules through condensation.

2. The method of extracting the coffee liquid according to claim 1, wherein said extraction solvent contains the fruit sugar condensation compound at a concentration of 0.003 to 0.9 weight %.

3. An extraction solvent for extracting a coffee liquid is an aqueous solution containing a fruit sugar condensation compound.

4. The extraction solvent for extracting the coffee liquid according to claim 3, wherein said extraction solvent contains the fruit sugar condensation compound at a concentration of 0.003 to 0.9 weight %.
